(19) United States
(12) Patent Application Publication
(10) Pub. No.: US 2011/0196800 A1
(43) Pub. Date: Aug. 11, 2011

(54) SYSTEMS AND METHODS FOR ENSURING COMPLETENESS OF AUTOMOTIVE REPAIR

(76) Inventors: ELAINNA SACHIRE, Gold Canyon, AZ (US); Jack Billington, Gravois Mills, MO (US)

(21) Appl. No.: 13/022,797

(22) Filed: Feb. 8, 2011

Related U.S. Application Data
(60) Provisional application No. 61/302,223, filed on Feb. 8, 2010.

(51) Int. Cl. G06Q 10/00

(52) U.S. Cl. 705/317

(57) ABSTRACT

A system and method of ensuring completeness of automotive repair according to various aspects of the present invention comprises a criteria compliance system linked to a criteria analysis system. The criteria compliance system is adapted to provide a framework for relaying third party requirements to a repair facility. The criteria compliance system may also collect information regarding the third party requirements, such as which requirements are performed by the repair facility. The criteria analysis system analyzes the collected information to identify any noncompliances between the third party requirements and actions taken by the repair facility and may reduce the need for human inspection to ensure that a repair facility has complied with the third party requirements.

### CROSS-REFERENCES TO RELATED APPLICATIONS

This application claims the benefit of U.S. Provisional Patent Application No. 61/302,223, filed on Feb. 8, 2010, and incorporates the disclosure of that application in its entirety by reference. To the extent that the present disclosure conflicts with any referenced application, however, the present disclosure is to be given priority.

### BACKGROUND OF INVENTION

Repair facilities generally have internal processes and procedures that are followed during a repair. In some instances, such as automotive repair and/or auto body collision repair, the repair facility is subject to additional requirements established by third parties. For example, an auto insurance provider may be financially responsible for repairs made to an automobile following an accident and as a result, the insurer may require that the repair facility perform processes or procedures that are not part of the facility's normal routine. Often, the repair facility may be unaware of the additional requirements or may not perform the additional requirements resulting in delays or additional cost.

To ensure that third party requirements are met, the third party may send an agent to the repair facility to inspect the repair for compliance with the requirements. Depending on the type or scale of repair, an agent may have to make several trips to a repair facility prior to completion. Such activity may increase the overall cost of the repair and/or delay completion of the repair while the repair center stops work to await an inspection.

### SUMMARY OF THE INVENTION

A system and method of ensuring completeness of automotive repair according to various aspects of the present invention comprises a criteria compliance system linked to a criteria analysis system. The criteria compliance system is adapted to provide a framework for relaying third party requirements to a repair facility. The criteria compliance system may also collect information regarding the third party requirements, such as which requirements are performed by the repair facility. The criteria analysis system analyzes the collected information to identify any noncompliances between the third party requirements and actions taken by the repair facility and may reduce the need for human inspection to ensure that a repair facility has complied with the third party requirements.

### BRIEF DESCRIPTION OF THE DRAWINGS

A more complete understanding of the present invention may be derived by referring to the detailed description when considered in connection with the following illustrative figures. In the following figures, like reference numbers refer to similar elements and steps throughout the figures.

FIG. 1 representatively illustrates a system for managing compliance with third party process requirements in accordance with an exemplary embodiment of the present invention;

FIG. 2 representatively illustrates a major category of a data entry form in accordance with an exemplary embodiment of the present invention;

FIG. 3 illustrates a set of data entry fields for a data entry form in accordance with an exemplary embodiment of the present invention;

FIG. 4 illustrates a second set of data entry fields for a data entry form in accordance with an exemplary embodiment of the present invention;

FIG. 5 is a flow chart representatively illustrating a quality assurance process in accordance with an exemplary embodiment of the present invention; and

FIG. 6 is a flow chart representatively illustrating several repair stages subject to a quality assurance process in accordance with an exemplary embodiment of the present invention.

### DETAILED DESCRIPTION OF EXEMPLARY EMBODIMENTS

The present invention may be described in terms of functional block components and various processing steps. Such functional blocks may be realized by any number of components configured to perform the specified functions and achieve the various results. For example, the present invention may employ various data collection devices, computers, and the like, which may carry out a variety of functions. In addition, the present invention may be practiced in conjunction with any number of processes such as automotive collision repair, mechanical repair services, and other services requiring a measurable outcome, and the system described is merely one exemplary application for the invention. Further, the present invention may employ any number of conventional techniques for receiving and processing data, analyzing and reporting data, and the like.

Systems and methods for ensuring completeness of automotive repair according to various aspects of the present invention may operate in conjunction with any suitable repair and/or manufacturing process. Various representative implementations of the present invention may be applied to any system for tracking the progress of a repair and ensuring that the repair process is performed according to specification. Certain representative implementations may include, for example, finable forms, checklists, databases, and/or use of a predetermined set of criteria designed to be carried out in a particular order.

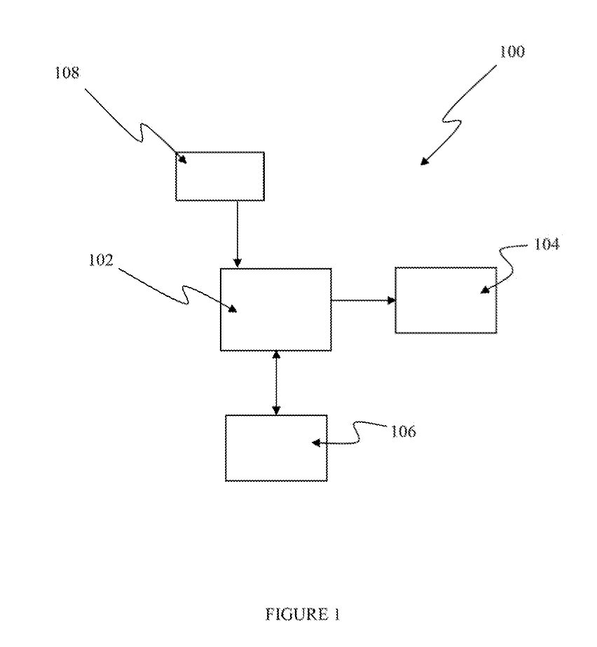

Referring now to FIG. 1, the systems and methods for ensuring completeness of automotive repair may, in practice, comprise a Criteria Compliance System 102 linked to a Criteria Analysis System 104 and at least one input device 108. The Criteria Compliance System 102 may also be communicatively linked to a second Criteria Analysis System 106.

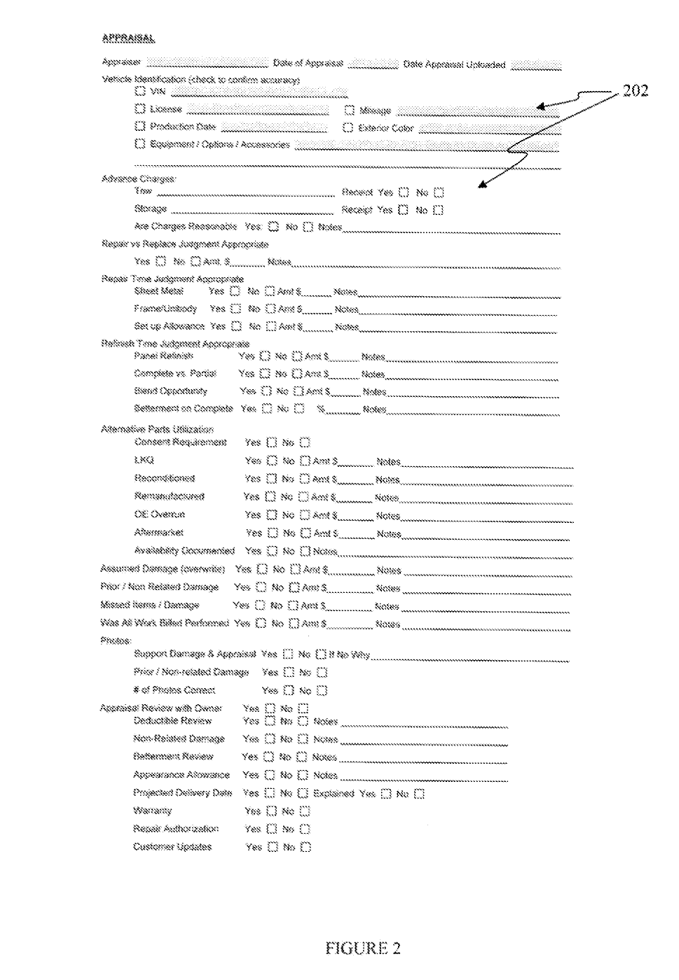

The Criteria Compliance System 102 collects and manages repair information corresponding to a set of predetermined repair specifications. The Criteria Compliance System 102 may comprise any suitable system for presenting the set of predetermined repair specifications and collecting the repair information from a repair facility tasked with performing a given vehicle repair. For example, the Criteria Compliance System 102 may comprise a data entry form with predefined fields that may include a section to be filled in with the repair information as the repair process progresses. Each predefined field may be related to a particular stage and/or step of the repair process corresponding to the set of predetermined repair specifications. For example, referring to FIG. 2, the data entry form may include a variety of different type of data entry fields 202 including, but not limited to, blank fields and check boxes.

The set of predetermined repair specifications may comprise any suitable criteria or information, such as questions pertaining to a particular stage of the repair process, directions to guide a repair facility through the repair process in a particular manner, or information with a focus based on a particular viewpoint which may be different from that of the repair facility. The criteria may also include information such as a collection of requirements for ensuring that a repair process is followed according to a standard. For example, the standard may comprise a series of steps and/or questions concerning the repair process established by an industry standard, legal statute, a requirement from an entity that is financially responsible for the costs associated with the repair.

The criteria may also comprise information that is of particular relevance to a party other than the repair facility. For example, referring again to FIG. 2, an insurance carrier may be concerned with variances in cost and/or materials from the initial estimate for one or more stages of the repair process. Therefore, the set of predetermined repair specifications may also comprise a series of questions pertaining to differences between the initial appraisal and a final or actual cost.

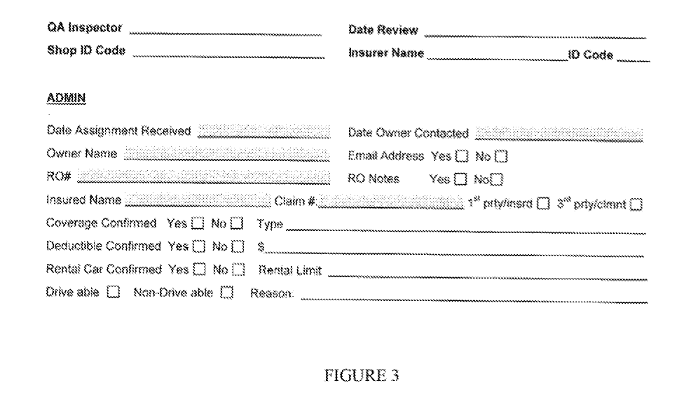

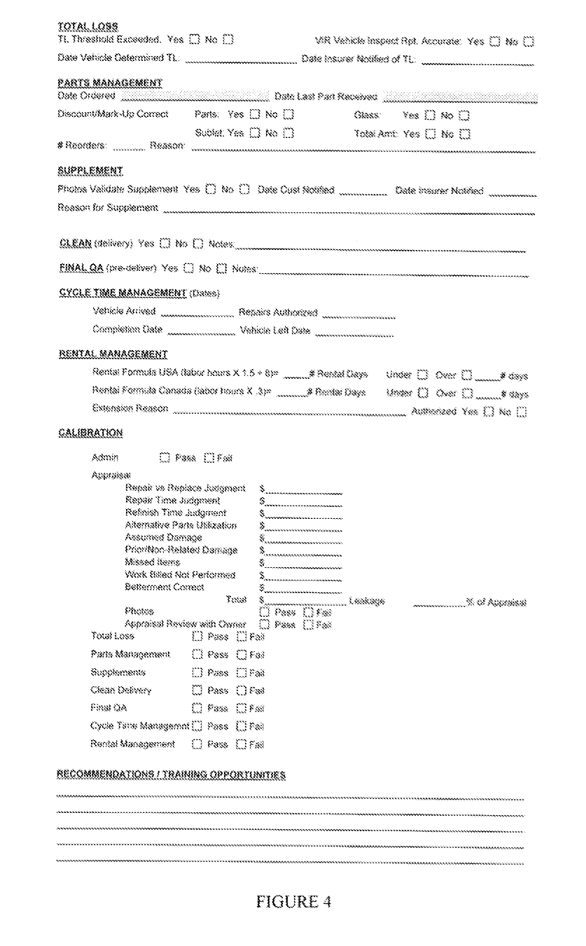

The set of predetermined repair specifications may also comprise multiple categories and/or subcategories of data. For example, each stage of a repair process may have a set of more detailed criteria for which data can be collected. Referring now to FIGS. 2-4, major categories of the repair process may have several related subcategories. Each of the subcategories may comprise data entry fields 202 displayed in a format that facilitates completion by the repair facility in a manner consistent with the general process flow of the subcategory. As the repair process progresses, the criteria set out in each major category is completed by the repair facility thereby ensuring that the repair is conducted according to the set of predetermined repair specifications.

Repair information entered into the data fields 202 may then be processed by any suitable input device 108 such as a digitizer, scanner, transcription into an electronic file or data analysis program, and the like to allow for later use and/or analysis. In another embodiment, the Criteria Compliance System 102 may comprise a computerized database in which data entry fields 202 pertaining to one or more records may be electronically filled in throughout the repair process. The form and/or database may be accessible by any suitable number of persons such as repair technicians, account managers, Quality Assurance (“QA”) agents, customer service representatives, and/or the like.

The set of set of predetermined repair specifications and/or the associated data entry form may be distributed to a repair facility or group of repair facilities by any suitable method. For example, a repair facility may have to agree to follow the set of predetermined repair specifications prior to entering into a contract with a given insurance carrier. Alternatively, the repair facility may be part of an association of repair facilities which together utilize the set of predetermined repair specifications during the course of conducting each repair. In another embodiment, a repair facility may subscribe to a service that supplies the form and/or database containing the predetermined repair specifications, compiles the collected data, analyzes the data, and reports the results back to the repair facility.

The Criteria Analysis System 104 processes the collected repair information. The Criteria Analysis System 104 may comprise any suitable system for analyzing the repair information and/or converting raw repair information into useable information. For example, repair information corresponding to a completed vehicle repair may be used processed by the Criteria Analysis System 104 and compared to the set of predetermined repair specifications to identify any noncompliances between the completed repair and the predetermined repair specifications. Alternatively, the Criteria Analysis System 104 may process partially entered repair information and present it to a QA agent at the repair facility to ensure that a given repair stage is completed in accordance with the set of predetermined repair specifications before a subsequent repair stage is started.

The Criteria Analysis System 104 may process collected repair information for multiple individual repair to review specific stages of the repair process for inefficiencies, process variability, improvement opportunities, targeted quality performance levels, effectiveness of corrective actions, and the like. The data, represented by a collection of completed forms and/or a populated database, may also be used as an auditing tool for ensuring compliance with the set of criteria. For example, the Criteria Analysis System 104 may be further adapted to perform an audit of the data in a randomly selected manner, a calculated sampling plan, or each repair may be individually reviewed. The Criteria Analysis System 104 may also process the collected repair information for use as part of an employee review and/or development program for employee training.

Referring again to FIG. 1, in another embodiment, the collected repair data may be provided to another party for additional analysis. For example, the Criteria Compliance System 102 may be further adapted transfer the collected repair data to a second Criteria Analysis System 106 operated by a third party, such as an insurance carrier, who may compile the repair information for multiple repair facilities. These larger samples may be used to create a scorecard for a particular repair facility based on factors relating to the information collected or compare repair facilities to each other. This global analysis of data may also be used for any other suitable purpose, such to track improvement efforts over time, document that standards are being met, or provide a list of preferred repair facilities to a customer.

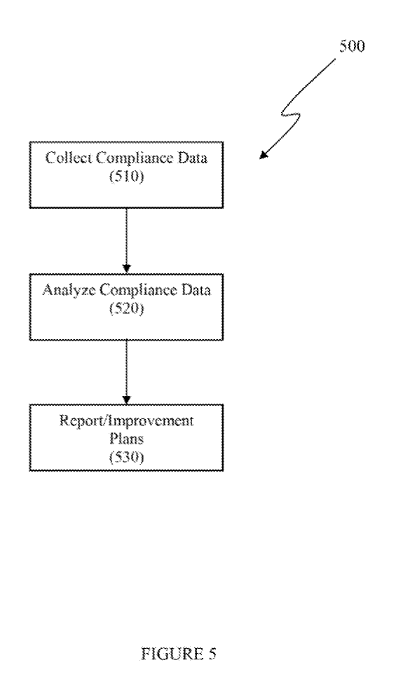

Referring now to FIG. 5, in one embodiment, systems and methods for ensuring completeness of automotive repair may comprise a quality assurance process 500 adapted to collect repair information corresponding to a set of predetermined criteria (510) that is to be followed and met by a repair facility. The process may also be adapted to provide feedback to the repair facility concerning the completeness of the repair and/or compliance with the set of predetermined criteria. For example, the collected repair information can be analyzed (520) following the completion of the repair. Data concerning an individual repair may also be compiled into a database with a larger set of data comprising data from repairs performed on other vehicles. This larger set of data may then be analyzed for a more global perspective. The results of the global analysis may be used for various reasons, including but not limited to improving a particular repair facility's ability to comply with the predetermined criteria, reduce variability in the repair process, evaluate various entities or groups that participate in the repair process, and/or alter the set of criteria (530).

The process and/or associated analysis may also be used to identify and reduce the potential for fraud in the repair process, either by the repair facility, a customer, or a third party. For example, in an automotive collision repair facility, the analyzed data may be used to ensure that only repairs consistent with a given accident are performed and/or charged to a party with financial responsibility for damages resulting from the accident.

The disclosed systems and methods may also reduce overall costs associated with a given repair by eliminating the need for a representative to visit the repair facility and visually inspect a given repair for compliance with the set of specification requirements. For example, the systems and methods may include a specific set of criteria that must be met before a repair can be considered complete by a given third party, such as an insurance carrier. In this way, the repair facility will not be caught unaware of a particular requirement or a demand from the third party. Not only may this reduce costs, but it may also reduce the amount of time spent by the repair facility trying to meet a set of unknown third party requirements.

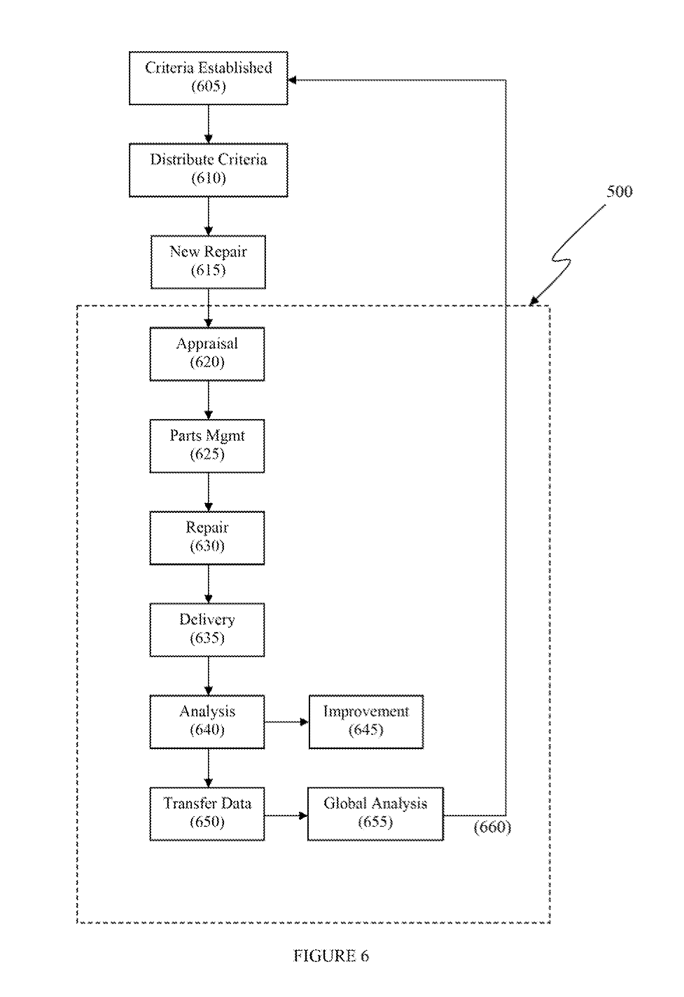

The systems and methods may also be used as a continuous improvement tool. For example, referring now to FIGS. 5 and 6, in one embodiment, the systems and methods may be used to sample a given process for compliance and/or completeness (520) (640). In this embodiment, an entity such as an insurance carrier, may request that the repair process be documented according to the systems and methods such that the compliance data may be used as an auditing tool. In this manner, the systems and methods may serve to drive a given repair facility to follow a particular process in an on-going fashion to ensure compliance with a set of requirements pertaining to the repair.

Referring now to FIG. 6, in operation, a predetermined set of repair specifications for ensuring the completeness of a repair process may be created (605) and distributed to at least one repair facility (610) for use. In one embodiment, the set of repair specifications may comprise a series of questions or attributes pertaining to the repair that is presented to a repair facility as a fillable form. The criteria may begin with an automobile in need of repair following an accident (615). This automobile may first be presented to the repair facility as a customer requesting an estimate or one that is subject to an appraisal (620) after an insurance provider has agreed to cover the costs associated with the repair. At this stage an appraiser may be required to enter data into the form following completion of the appraisal. Once a repair is started, the process may advance to a stage where parts must be ordered and/or tracked (625) to ensure they are available when the actual repair occurs (630). The criteria may also include factors relevant to the delivery process (635) thereby ensuring that factors essential for a complete and accurate repair have been accomplished prior to delivery to the customer.

After the repair has been completed, the collected data may be analyzed (640) to check the rate of compliance of the repair against the set of repair specifications. This analysis may be used by the repair facility to target improvements (645) in their own processes or to identify potential sources of variability in their processes. Collected repair information may also be transferred (650), or otherwise uploaded to another party for additional analysis (655). For example, repair information may be collected by an insurance carrier as part of a collaborative improvement effort between the insurance carrier and the repair facility. In one embodiment, the insurance carrier may compare the results of one repair facility against those of another repair facility in an attempt to identify a series of best practices directed at helping the repair facility improve its internal processes.

In another embodiment, data analysis results may be used to update, modify, or otherwise improve the set of repair specifications used to track the repair process (660). This feature may act as a positive feedback loop into the overall compliance process to ensure that the disclosed system is not static but can adapt and evolve as new information is gathered.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing description, the invention has been described with reference to specific exemplary embodiments. Various modifications and changes may be made, however, without departing from the scope of the present invention as set forth. The description and figures are to be regarded in an illustrative manner, rather than a restrictive one and all such modifications are intended to be included within the scope of the present invention. Accordingly, the scope of the invention should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present invention and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

The terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

The present invention has been described above with reference to an exemplary embodiment. However, changes and modifications may be made to the exemplary embodiment without departing from the scope of the present invention. These and other changes or modifications are intended to be included within the scope of the present invention.

1. A system for managing compliance with third party process requirements by a repair facility during a vehicle repair process, comprising:
a criteria compliance system adapted to:
present the repair facility with a predetermined set of repair specifications corresponding to the vehicle repair process;
collect repair information from the repair facility pertaining to the predetermined set of repair specifications; and
save the repair information; and
a criteria analysis system linked to the criteria compliance system and adapted to process the saved repair information to identify any noncompliance with the predetermined set repair specifications.

2. A system for managing compliance with third party process requirements by a repair facility according to claim 1, wherein the criteria compliance system comprises a data entry form corresponding to each step in the vehicle repair process.

3. A system for managing compliance with third party process requirements by a repair facility according to claim 2, wherein:
the data entry form is adapted to be presented via an electronic display device; and
the repair information is received via a computer terminal.

4. A system for managing compliance with third party process requirements by a repair facility according to claim 1, further comprising a database coupled to the criteria analysis system, wherein the database is adapted to store the saved repair information corresponding to repairs performed on different vehicles.

5. A system for managing compliance with third party process requirements by a repair facility according to claim 4, wherein the criteria analysis system is further adapted to process the repair information in the database to identify at least one of noncompliance rates, process variability, fraud, cost variance, and effectiveness of improvement efforts.

6. A system for managing compliance with third party process requirements by a repair facility according to claim I, wherein the criteria analysis system is further adapted to monitor each stage of the repair process and signal the repair facility when a group of repair specifications within a particular stage has not been completed.

7. A system for managing compliance with third party process requirements by a repair facility according to claim 1, the criteria analysis system comprises a feedback system adapted to identify areas of improvement within the repair process.

8. A computer-implemented method of tracking and monitoring compliance with third party process requirements by a repair facility performing a vehicle repair process, comprising:
coupling a criteria compliance system to a repair facility computer system having a processor, a memory device, and a display;
presenting a predetermined set of repair specifications generated by the criteria compliance system on the display, wherein the set of repair specifications corresponds to the vehicle repair process;
saving repair information to the memory device, wherein the repair information is entered into the computer system by the repair facility in response to the predetermined set of repair specifications; and
processing the repair information with a criteria analysis system linked to the criteria compliance system, wherein the criteria analysis system is adapted to identify any noncompliances between the repair information and the predetermined set of repair specifications.

9. A computer implemented method according to claim 8, wherein presenting the predetermined set of repair specifications comprises displaying a data entry form having data entry fields corresponding to at least one step in the vehicle repair process.

10. A computer implemented method according to claim 9, wherein the repair information is received via an input device coupled to a computer system.

11. A computer implemented method according to claim 8, further comprising coupling a database to the criteria analysis system, wherein the database is adapted to store the repair information corresponding to repairs performed on different vehicles.

12. A computer implemented method according to claim 11, further comprising processing the repair information stored in the database to identify at least one of noncompliance rates, process variability, fraud, cost variance, and effectiveness of improvement efforts.

13. A computer implemented method according to claim 8, further comprising:
monitoring each stage of the repair process; and
signaling the repair facility when a group of repair specifications within a particular stage has not been completed.

14. A method of tracking and monitoring compliance with third party process requirements by a repair facility performing a vehicle repair process, comprising:
presenting a predetermined set of repair specifications to the repair facility, wherein the predetermined set of repair specifications corresponds to the vehicle repair process;
collecting repair information generated by the repair facility in response to the presented predetermined set of repair specifications; and
processing the repair information to identify any noncompliance between the repair information and the predetermined set of repair specifications.

15. A method according to claim 14, wherein presenting the predetermined set of repair specifications comprises displaying a data entry form having data entry fields corresponding to at least one step in the vehicle repair process.

16. A method according to claim 14, further comprising storing the repair information corresponding to repairs performed on different vehicles to a database.

17. A method according to claim 17, further comprising processing the repair information stored in the database to identify at least one of noncompliance rates, process variability, fraud, cost variance, and effectiveness of improvement efforts.
